(19) United States
(12) Patent Application Publication
(10) Pub. No.: US 2017/0320428 A1
(43) Pub. Date: Nov. 9, 2017

(54) RATCHET UNIT

(71) Applicant: DEREK E. BREST, SAN ANGELO, TX (US)

(72) Inventor: DEREK E. BREST, SAN ANGELO, TX (US)

(21) Appl. No.: 15/146,902

(22) Filed: May 5, 2016

(51) Int. Cl. B60P 7/08

(52) U.S. Cl. CPC B60P 7/0853; B60P 7/0807; B60P 7/083

(57) ABSTRACT

The present invention relates to a ratcheting unit enabling for securing cargo particularly for tightness in order to secure a load of cargo quickly and safely. Typically these ratcheting straps feature a first end with one length of strap secured to the first end via a bolt, and the other length of strap is fed through a ratcheting cylinder. The ratchet allows the user to hook the straps on the distal ends to a secure anchor point, i.e. the side of a trailer. The straps are pulled taught, the loose strap is fed through the ratcheting cylinder and the ratchet handle is used to tighten the slack in the strap, bringing the strap to a higher tension than what one could easily achieve without the aid of a ratchet to hold the tension and provide leverage for taking in further slack.

### FIELD OF THE INVENTION

The present invention relates to a ratcheting unit enabled with straps and hooks for securing cargo, particularly for tightness.

### BACKGROUND OF THE INVENTION

Usually, the various vehicles used for carrying goods around places face problems when carrying goods safely and conveniently while avoiding losing, dropping, slipping and breaking goods. Moreover, cargo on a flatbed truck must be secured by straps for transportation, and the straps are frequently tightened by ratchet straps to prevent the items from being lost or damaged.

Commonly used ratchets for securing cargo that are currently available rely on a ratcheting handle and attached spool to tighten the straps that are fed through the spool of the ratchet. These ratcheting handles provide a limited range of motion and limit the amount of leverage that can be applied to the strap for securing the cargo. Further the unused portion of the straps hang freely from the ratchet, these straps become weathered and damaged rapidly when allowed to trail freely during transportation. Securing the slack from the unused portion of the straps prior to moving the cargo is time consuming. In addition the hooks attached to the ends of the straps limit the anchor points they can be attached to by nature of their shape, and require extra steps or modifications in order to be used on certain vehicles before the load can be secured.

Therefore, there remains a need to overcome above mentioned problems and our invention resolves the same.

### SUMMARY OF THE INVENTION

The main objective of the present invention is to overcome the limitations of the prior arts by providing a ratcheting unit enabled for securing cargo particularly in order to tighten the strap with increased leverage, and to contain unused slack in the straps quickly for storage or while securing a load of cargo for transportation.

The present invention relates to a ratcheting unit in one embodiment comprised of a rotating cylinder coupled to a ratcheting handle and a fully rotating handle, attached to the body of the ratchet is a strap of fixed length with a hook attached, attached to the rotating cylinder is a strap of fixed length with a hook attached that can be taken up around the cylinder to reduce the available length, thereby providing tension.

The cylinder housing has increased area around the cylinder so as to take up all the slack of the strap around the ratcheting cylinder, preventing the need to fold, roll-up, zip-tie, etc any slack.

The ratchet handle features a comfortable grip release lever for the ratchet with increased clearance between the cylinder and gate release. This is to provide additional room for the strap taken up by the cylinder and to provide a more comfortable configuration for the user.

Coupled to the ratcheting cylinder is a rotating lever like that seen on a fishing rod, which when the ratchet is in the open, free turning position, will allow the user to rotate the ratcheting cylinder, quickly taking up any excess slack.

Placing the handle in its furthest position, releases the ratcheting cylinder wherein the ratcheting strap will become loose and enables pulling the ratcheting unit to loosen the ratcheting strap.

### BRIEF DESCRIPTION OF THE DRAWING

The following drawings illustrates but is not limited to an exemplary embodiment; however, they are helpful in illustrating objects, features and advantages of the present invention because the present invention will be more apparent from the following detailed description taken in conjunction with accompanying drawings in which:

FIG. 1 illustrates the perspective view of the given invention according to an embodiment of the invention.

FIG. 2 illustrates the flow chart of the given invention which is also the preferred embodiment of the given invention.

### DETAIL DESCRIPTION OF THE INVENTION

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent applications mentioned herein are incorporated herein in their entirety.

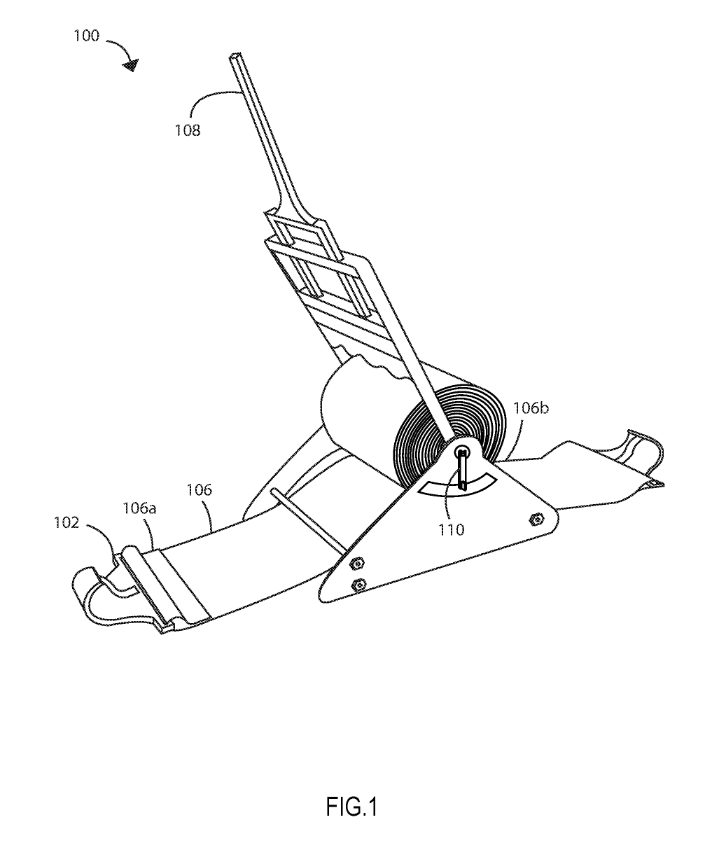

FIG. 1 illustrates the perspective view of the given invention of the ratcheting unit [100] comprises a ratcheting strap [106] wherein the ratcheting strap [102] has two ends i.e., the first end [106a] and second end [106b] wherein, the first end [106a] of the ratcheting strap [106] is coupled to the first end [102] of the ratcheting unit [100] and the second end [106b] is couple to the ratcheting cylinder [not shown] wherein the ratcheting strap [106] tie downs aid in securing a load and the ratcheting cylinder [not shown] take up extra slack in the strap [102], whether in use or being contained for storage, and the increased area around the ratcheting cylinder [not shown] take up all the slack of the strap [102] around the ratcheting cylinder [not shown], preventing the need to fold, roll-up, zip-tie, etc. the excess slack before stowing or transporting the load. This excess slack is normally left trailing out of the ratcheting unit [100] and needs to be contained to prevent advanced wear of the material, and in some places the containment of the slack is a requirement by law. The ratcheting unit [100] further comprises of a lever [110] that is seen on a fishing rod, which when the ratcheting unit [100] is in the open, free turning position, will allow the user to rotate the ratcheting cylinder [not shown] quickly taking up any excess slack wherein when not in use the lever [101] is rotated perpendicularly on its axis to stow conveniently in a cut out slot in the base and also, when deploying the ratcheting strap [106], the ratcheting unit [100] can be put into the open, free turning position, and the desired length of the ratcheting strap [106] can be pulled from the ratchet unit [100] and attached to the first end [102]. The handle [108] equipped in the ratcheting unit [100] with receiving holes and at least two pronged handle extension that fits into the receiving holes of the handle [108]. The extender provides additional length from the fulcrum of the ratcheting unit [100] the user is able to apply additional force, providing more torque to the ratchet unit [100]. This allows additional length of the ratcheting strap [106] to be taken up by the ratchet unit [100] and apply more tension to the load. The handle [108] extender may be removed when not in use and stowed separately.

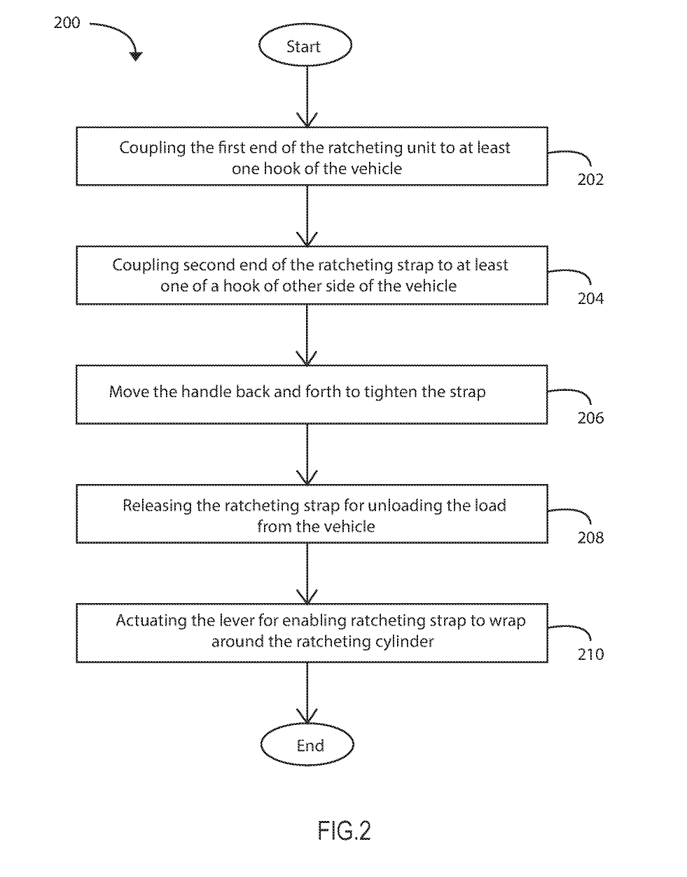

FIG. 2 illustrates the flow chart [200] of the given invention of a ratcheting unit comprising:

Step.202 of FIG. 2 illustrates coupling a first end of the ratcheting unit to at least one of a hook of a vehicle wherein, the first end of the ratcheting unit is coupled to one end of the ratcheting strap wherein the ratcheting strap aid in securing a load and the excess length in the strap must be rolled up or otherwise contained, both before transporting a load while the strap is in use, and after the strap has been removed and is to be stored.

Step.204 of FIG. 2 illustrates coupling a second end of a ratcheting strap to at least one of a hook on the other side of the vehicle wherein, the second end of the ratcheting strap is further coupled to a ratcheting cylinder wherein the present invention provides an increased area around the ratcheting cylinder so as to take up all the extra slack or extra length of the ratcheting strap around the ratcheting cylinder, preventing the need to fold, roll-up, zip-tie, etc. the excess length of the ratcheting strap before stowing or transporting the load. This excess length of the strap is normally left trailing out of the ratcheting unit and needs to be contained to prevent advanced wear of the material, and in some places the containment of the length of the ratcheting strap is a requirement by law.

Step.206 of FIG. 2 illustrates actuating the ratcheting handle to tighten the strap which enables securing the load in its position using the ratcheting unit with receiving holes and a two pronged handle extension that fits into the receiving holes of the handle. The extender provides additional length from the fulcrum of the ratcheting unit and the user is able to apply more force, providing more torque to the ratcheting unit. This allows additional length of the strap to be taken up by the ratcheting unit and apply more tension to the load. The handle extender may be removed when not in use and stowed separately.

Step.208 of FIG. 2 releasing the ratcheting strap wherein, the ratcheting handle is put in its farthest position opening the gate that engages with the ratcheting cylinder, the cylinder is allowed to turn freely enabling the retraction of the ratcheting strap back to the ratcheting unit which is used for unloading the load.

Step.2010 of FIG. 2 illustrates actuating a lever coupled to the ratcheting unit in circular motion wherein, the circular motion of the lever enables the ratcheting strap to wrap around the ratcheting cylinder when the ratchet is in the open, free turning position, will allow the user to rotate the ratcheting cylinder, quickly taking up any excess slack. When not in use the rotating lever can be rotated perpendicularly on its axis to stow conveniently in a cut out slot in the base wherein on deploying the strap, the ratcheting unit is put into the open, free turning position, and the desired length of the ratcheting strap can be pulled from the ratchet and attached to the first end.

While the invention has been described in detail with specific reference to preferred embodiments thereof, it is understood that variations and modifications thereof may be made without departing from the true spirit and scope of the invention.

What is claimed is:

1. A ratchet unit securing load comprising:
a. a ratcheting strap coupled to a ratcheting cylinder wherein, the ratcheting cylinder is coupled to a second end of the ratcheting strap wherein the ratcheting cylinder enables adjusting the length of the ratcheting strap;
b. a first end of the ratcheting unit coupled to a first end of the ratcheting strap wherein the first end of the ratcheting unit enables securing the one end of the ratcheting strap coupled to it; and
c. a handle wherein, the handle is used to tighten the ratcheting strap and bring the ratcheting strap to higher tension.

2. The ratchet unit of claim 1, wherein the extra length of the ratcheting strap is either rolled up or contained both while the ratcheting strap is in use or not in use.

3. The ratchet unit of claim 1, wherein to take up extra slack in the ratcheting strap either in use or being contained for storage, there is provided an increased area around the ratcheting cylinder so as to take up all the slack of the ratcheting strap around the ratcheting cylinder, preventing the need to fold, roll-up and zip-tie.

4. The ratchet unit of claim 1, wherein the handle has a rotating lever which when ratchet allows the user to rotate the ratcheting cylinder and quickly taking up any excess slack.

5. The ratchet unit of claim 1, wherein ratcheting unit is provided with at least one of a flat hook wherein the flat hook allows the ratcheting strap to be anchored to a wider variety of an anchor points.

6. The ratchet unit of claim 1, wherein the handle consists of a handle extender which is removed when not in use and stowed separately.

7. The ratchet unit of claim 6, wherein the handle extender provides additional length from the fulcrum of the ratchet unit which in turn provides more torque to the ratchet unit.

8. A method for securing a load via ratcheting unit comprising:
a. coupling a first end of the ratcheting unit to at least one anchor point of a vehicle wherein, the first end of the ratcheting unit is coupled to one end of the ratcheting strap;
b. coupling a second end of a ratcheting strap to at least one of a hook on the other side of the vehicle wherein, the second end of the ratcheting strap is further coupled to a ratcheting cylinder;
c. putting the ratcheting handle in its further position which frees the gears of the ratcheting cylinder to turn freely and enables retracting of the ratcheting strap back to the ratcheting unit; and
d. actuating a lever coupled to the ratcheting unit wherein, actuation of the lever enables the ratcheting strap to wrap around the ratcheting cylinder and take up excess length of the ratchet strap.

9. The method of claim 8, wherein the extra length of the ratcheting strap is either rolled up or contained both while the ratcheting strap is in use or not in use.

10. The method of claim 8, wherein to take up extra length of the ratcheting strap either in use or being contained for storage, there is provided an increased area around the ratcheting cylinder so as to take up extra length of the ratcheting strap around the ratcheting cylinder, preventing the need to fold, roll-up and zip-tie.

11. The method of claim 8, wherein the handle has a rotating lever which when ratchet allows the user to rotate the ratcheting cylinder and quickly taking up any excess slack.

12. The method of claim 8, wherein ratcheting unit is provided with at least one of a flat hook wherein the flat hook allows the ratcheting strap to be anchored to a wider variety of a anchor points.

13. The method of claim 8, wherein the handle consists of a handle extender which is removed when not in use and stowed separately.

14. The method of claim 8, wherein the handle extender provides additional length from the fulcrum of the ratchet unit which in turn provides more torque to the ratchet unit.

15. The method of claim 8, wherein the actuating lever coupled to the ratcheting unit enables its movement in the circular direction.
